(19) United States
(12) Patent Application Publication
(10) Pub. No.: US 2026/0277267 A1
(43) Pub. Date: Sep. 17, 2026

(54) FREQUENCY ADJUSTMENT DEVICE AND FREQUENCY ADJUSTMENT METHOD

(71) Applicant: Realtek Semiconductor Corporation, Hsinchu (TW)

(72) Inventors: Chang-Hao CHIU, Hsinchu (TW); Han-Chieh HSIEH, Hsinchu (TW); Ching-Feng HUANG, Hsinchu (TW)

(21) Appl. No.: 19/562,814

(22) Filed: Mar. 11, 2026

(30) Foreign Application Priority Data
Mar. 14, 2025 (TW) 114109656

(51) Int. Cl. G06F 1/08; G06F 1/06

(52) U.S. Cl. CPC G06F 1/08; G06F 1/06

(57) ABSTRACT

A frequency adjustment device operating based on a power supply and an operation frequency is provided, comprising: a clock supply circuit, configured to output one of multiple clock signals as a supply clock signal; a clock gating component, configured to gate the supply clock signal to generate an output clock signal; and a control circuit, configured to: when a voltage variation slope of the power supply is less than a critical slope, reduce a frequency of the output clock signal; when the voltage variation slope is greater than zero, increase the frequency of the output clock signal; and when the voltage variation slope is maintained in a stable slope range for a specified period, control the clock supply circuit to select one clock signal with the operation frequency as the supply clock signal, and adjust the frequency of the output clock signal to which of the selected clock signal.

### RELATED APPLICATIONS

This application claims priority to Taiwan Application Serial Number 114109656, filed on March 14, 2025, which is herein incorporated by reference in its entirety.

### BACKGROUND

### Technical Field

The present disclosure relates to frequency adjustment technology. More particularly, the present disclosure relates to a frequency adjustment device and a frequency adjustment method for adjusting the frequency of a clock signal based on a voltage variation slope of a power supply.

### Description of Related Art

The processor of a system-on-a-chip (SoC) may cause a momentary voltage drop in the supply voltage due to executing heavy-loaded programs, which may lead to insufficient timing margin and cause the electronic circuit to fail. Therefore, in some technologies, when a voltage drop in the supply voltage is detected, the clock frequency is quickly reduced (i.e., a frequency division is performed) to reduce the power consumption of the circuit, so that the supply voltage can be restored to its original level.

However, the above-mentioned operation may cause the circuit to trigger the frequency division operation when the frequency division is not necessary (e.g., when the voltage is temporarily close to a critical value), thereby causing a decrease in the operation capability. Therefore, how to more accurately determine whether to divide the frequency of the clock signal is one of the topics in this field.

### SUMMARY

A frequency adjustment device is provided in the present disclosure. The frequency adjustment device operates based on a power supply and an operation frequency, and comprises a clock supply circuit, a clock gating component and a control circuit. The clock supply circuit is configured to output one of a plurality of clock signals as a supply clock signal. The clock gating component is configured to gate the supply clock signal to generate an output clock signal. The control circuit is configured to: when a voltage variation slope of the power supply is less than a first critical slope, reduce a frequency of the output clock signal, wherein the first critical slope is less than zero; when the voltage variation slope of the power supply is greater than zero, increase the frequency of the output clock signal; and when the voltage variation slope is maintained in a stable slope range for a specified time period, control the clock supply circuit to select a first clock signal of the plurality of clock signals as the supply clock signal, and adjust the frequency of the output clock signal to a frequency of the first clock signal. The frequency of the first clock signal is the same as the operation frequency.

A frequency adjustment method is provided in the present disclosure. The frequency adjustment method is suitable for a frequency adjustment device operating based on a power supply and an operation frequency, and comprises: outputting, by a clock supply circuit, one of a plurality of clock signals as a supply clock signal; gating, by a clock gating component, the supply clock signal, so as to generate an output clock signal; in response to a voltage variation slope of the power supply being less than a first critical slope, reducing, by a control circuit, a frequency of the output clock signal, wherein the first critical slope is less than zero; in response to the voltage variation slope being greater than zero, increasing, by the control circuit, the frequency of the output clock signal; and in response to the voltage variation slope being maintained in a stable slope range for a specified time period: selecting, by the clock supply circuit, a first clock signal of the plurality of clock signals as the supply clock signal; and adjusting, by the control circuit, the frequency of the output clock signal to a frequency of the first clock signal, wherein the frequency of the first clock signal is the same as the operation frequency.

With the frequency adjustment device and the frequency adjustment method of the present disclosure, the frequency of the output clock signal can be adjusted based on the voltage variation slope of the power supply, thereby alleviating the situation where the operating capacity is reduced due to excessive triggering of the frequency division.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows.

FIG. 1 is a functional block diagram of a frequency adjustment device in accordance with some embodiments of the present disclosure.

FIG. 2 is a timing diagram of a supply clock signal and output clock signals under various clock parameters in accordance with some embodiments of the present disclosure.

FIG. 3 is a timing diagram of the voltage value and the voltage variation slope of a power supply in accordance with some embodiments of the present disclosure.

FIG. 4 is a flowchart of a frequency adjustment method in accordance with some embodiments of the present disclosure.

### DETAILED DESCRIPTION

For purposes of explanation, numerous specific details are described below so that the embodiments of the present disclosure can be fully understood. However, it is apparent that one or more embodiments can be implemented without these specific details. In other cases, conventional structures and devices are only schematically shown to simplify the drawings. Reference will now be made in detail to the present embodiments of the disclosure, examples of which are illustrated in the accompanying drawings. Wherever possible, the same reference numbers are used in the drawings and the description to refer to the same or like parts.

In the present disclosure, when an element is referred to as "connected", it may mean "electrically connected" or "signal connected". When an element is referred to as "coupled", it may mean "electrically coupled" or "signal coupled". "Connected" or "coupled" can also be used to indicate that two or more components operate or interact with each other. As used in the present disclosure, the singular forms "a", "one" and "the" are also intended to include plural forms, unless the context clearly indicates otherwise. It will be further understood that when used in this specification, the terms "comprises (comprising)", "includes (including)" and/or “haves (having)” designate the existence of stated features, regions, integers, steps, operations, elements and/or components, but the existence or addition of one or more other features, regions, integers, steps, operations, elements, components, and/or groups thereof are not excluded.

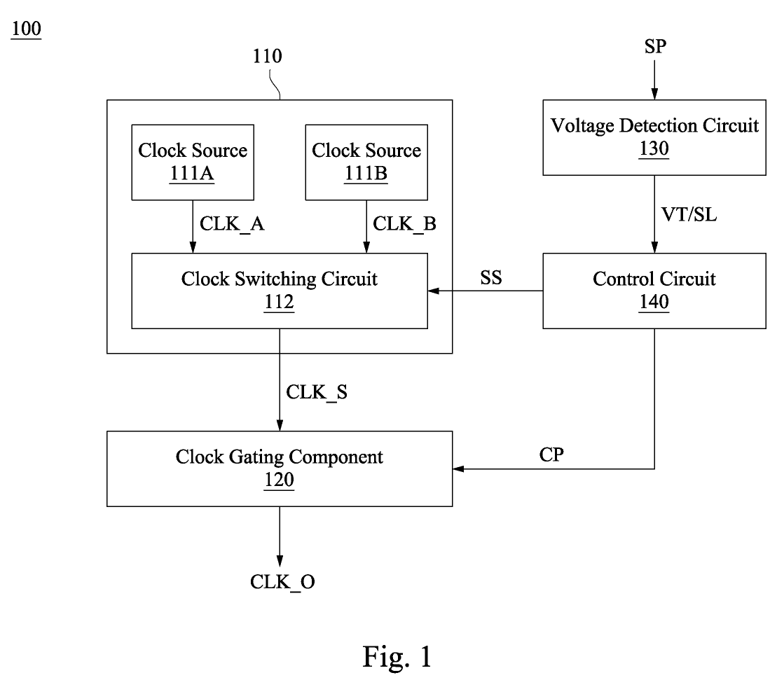

FIG. 1 is a functional block diagram of a frequency adjustment device 100 in accordance with some embodiments of the present disclosure. In some embodiments, the frequency adjustment device 100 comprises a clock supply circuit 110, a clock gating component 120, a voltage detection circuit 130 and a control circuit 140, and is configured to operate based on an operation frequency and a power supply SP.

The clock supply circuit 110 is coupled to the clock gating component 120 and the control circuit 140, and is configured to receive a selection signal SS from the control circuit 140 and output a corresponding supply clock signal CLK_S to the clock gating component 120 based on the selection signal SS. In some embodiments, the clock supply circuit 110 comprises clock sources 111A, 111B and a clock switching circuit 112.

The clock sources 111A and 111B are coupled to the clock switching circuit 112, and are configured to respectively generate clock signals CLK_A and CLK_B to the clock switching circuit 112. In some embodiments, the frequency of one of the clock signals CLK_A and CLK_B is equal to the operation frequency of the frequency adjustment device 100, and the frequency of the other one of the clock signals CLK_A and CLK_B is lower than the operation frequency of the frequency adjustment device 100.

The clock switching circuit 112 is coupled to the clock sources 111A, 111B, the clock gating component 120 and the control circuit 140, and is configured to receive the selection signal SS from the control circuit 140 and output one of the clock signals CLK_A, CLK_B received from the clock sources 111A, 111B to the clock gating component 120 as a supply clock signal CLK_S based on the selection signal SS. In some embodiments, the clock switching circuit 112 may be implemented with a combination of a plurality of switching circuits, wherein these switching circuits are respectively connected to the clock sources 111A, 111B to control one of the clock sources 111A, 111B to form a short circuit with the clock switching circuit 112, and the other to form an open circuit with the clock switching circuit 112, so as to achieve the switching of the clock signals.

The clock gating component 120 is coupled to the clock supply circuit 110 and the control circuit 140, and is configured to gate the supply clock signal CLK_S based on a clock parameter CP received from the control circuit 140, so as to generate an output clock signal CLK_O.

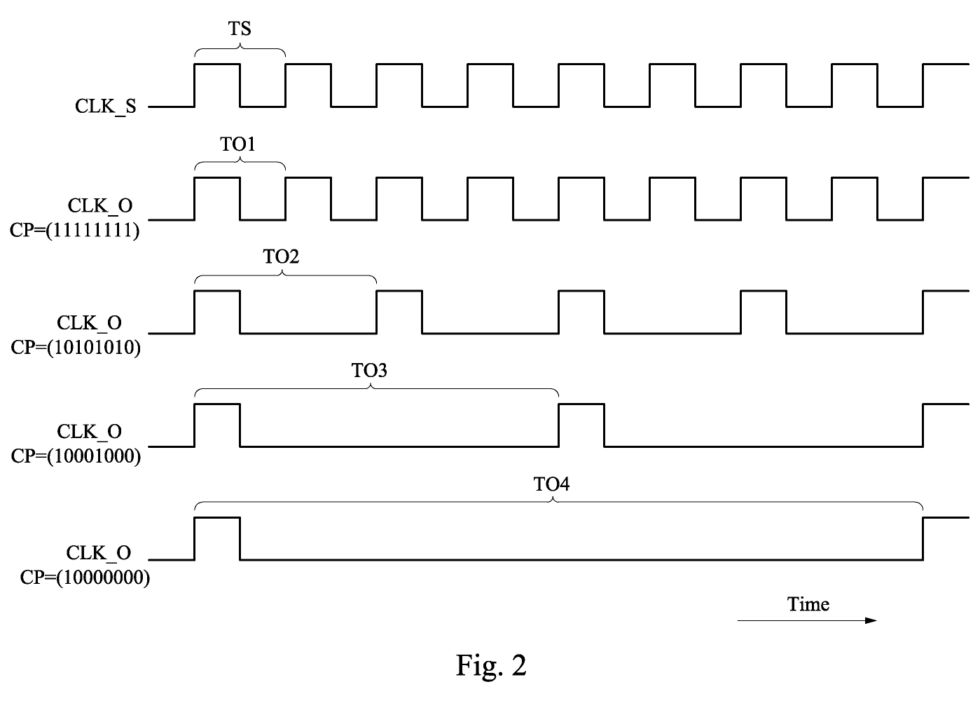

Regarding the manner in which the clock gating component 120 generates the corresponding output clock signal CLK_O based on the clock parameter CP, please refer to FIG. 2. FIG. 2 is a timing diagram of the supply clock signal CLK_S and the output clock signals CLK_O under various clock parameters CP in accordance with some embodiments of the present disclosure.

In some embodiments, the clock parameter CP is a digital signal comprising a plurality of bits. Taking the embodiment of FIG. 2 as an example, the clock parameter CP is a digital signal with 8 bits, wherein each bit has a logic low state (e.g., logic 0) or a logic high state (e.g., logic 1). Therefore, the clock parameter CP can be represented by a sequence such as “(11111111)”, “(10101010)”, etc. as shown in FIG. 2.

In some embodiments, the frequency of the output clock signal CLK_O is directly related to the number of bits of the clock parameter CP in the logic high state. Taking the embodiment of FIG. 2 as an example, the supply clock signal CLK_S has a period TS. When the clock parameter CP is the sequence "(11111111)", the output clock signal CLK_O will have a period TO1 that is the same as the period TS, so the frequency of the output clock signal CLK_O will be the same as the frequency of the supply clock signal CLK_S; when the clock parameter CP is the sequence "(10101010)", the period TO2 of the output clock signal CLK_O will be twice the period TS, so the frequency of the output clock signal CLK_O will be half of the frequency of the supply clock signal CLK_S; when the clock parameter CP is the sequence "(10001000)", the period TO3 of the output clock signal CLK_O will be four times the period TS, so the frequency of the output clock signal CLK_O will be one quarter of the frequency of the supply clock signal CLK_S; when the clock parameter CP is the sequence "(10000000)", the period TO4 of the output clock signal CLK_O will be eight times the period TS, so the frequency of the output clock signal CLK_O will be one eighth of the frequency of the supply clock signal CLK_S.

By the above-mentioned adjusting the bits of the clock parameter CP, the clock gating component 120 can generate output clock signals CLK_O of corresponding frequencies based on the clock parameter CP. It should be noted that although FIG. 2 shows that the rising edges of the output clock signals CLK_O are corresponding to the bits of the clock parameter CP in the logic high state (i.e., logic 1), the present disclosure is not limited thereto. In some embodiments not shown, the rising edges of the output clock signals CLK_O are corresponding to the bits in the clock parameter CP in the logic low state (i.e., logic 0), so the frequency of the output clock signal CLK_O is positively related to the number of bits of the clock parameter CP in the logic low state.

Please refer to FIG. 1 again. The voltage detection circuit 130 is coupled to the control circuit 140, and is configured to detect a voltage variation slope SL and a voltage value VT of the power supply SP, and transmit the detected voltage variation slope SL and the voltage value VT to the control circuit 140.

The control circuit 140 is coupled to the clock supply circuit 110, the clock gating component 120 and the voltage detection circuit 130, and is configured to generate the clock selection signal SS and the clock parameter CP based on the voltage variation slope SL and the voltage value VT of the power supply SP, so as to control the frequency of the output clock signal CLK_O output by the clock gate control component 120 in real time, so that the supply voltage can be quickly restored to its original value after experiencing a voltage drop.

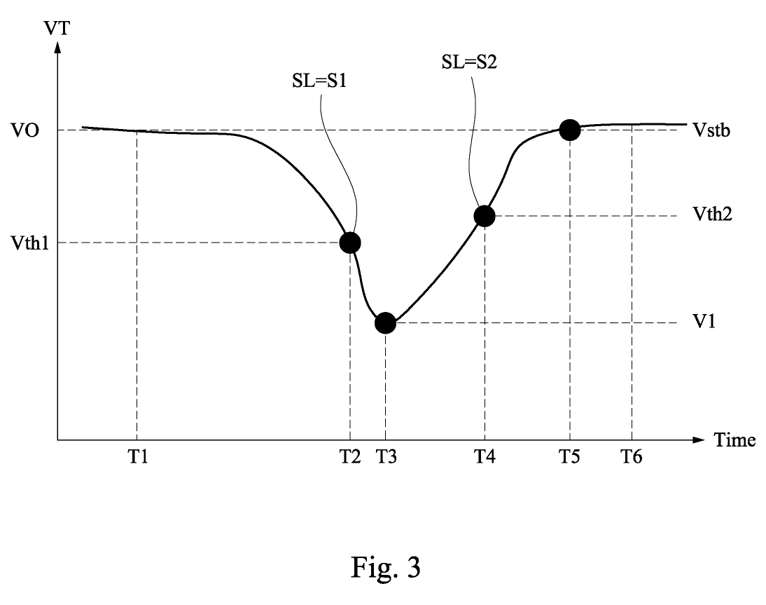

Specifically, please refer to FIG. 3. FIG. 3 is a timing diagram of the voltage value VT and the voltage variation slope SL of the power supply SP in accordance with some embodiments of the present disclosure.

Before time point T1, the system operates in a normal mode, so the voltage value VT during this time is maintained at an operation voltage value VO (e.g., of a processor), and the control circuit 140 may transmit the selection signal SS to control the clock supply circuit 110 to select a first clock signal with the same frequency as the operation frequency (e.g., the clock signal CLK_A in FIG. 1) among a plurality of clock signals as the supply clock signal CLK_S, and adjust the clock parameter CP to not gate the supply clock signal CLK_S (e.g., setting the sequence of the clock parameter CP to “(11111111)”), thereby making the output clock signal CLK_O equal to the first clock signal.

At time point T1, due to reasons such as the processor executing a heavy-loaded program, the voltage value VT begins to drop. In other words, starting from the time point T1, the voltage variation slope SL of the power supply SP changes to be less than zero.

Between the time point T1 and the time point T2 , the voltage variation slope SL of the power supply SP gradually drops, and drops to less than a first critical slope S1 at the time point T2. At the time point T2, the control circuit 140 adjusts the clock parameter CP to gradually reduce the frequency of the output clock signal CLK_O. In some embodiments, the first critical slope S1 is less than zero.

In some embodiments, in addition to determining whether to adjust the clock parameter CP based on the voltage variation slope SL, the control circuit 140 also determines whether to adjust the clock parameter CP based on whether the voltage value VT is less than a specific critical voltage value. In other words, in some embodiments, when the voltage variation slope SL of the power supply SP drops to lower than the first critical slope S1 and/or the voltage value VT is lower than the first critical voltage value Vth1, the control circuit 140 will adjust the clock parameter CP to gradually reduce the frequency of the output clock signal CLK_O.

Since the frequency of the output clock signal CLK_O is gradually reduced, the power consumption of the circuit will gradually decrease, and the voltage drop of the voltage value VT will gradually slow down. At time point T3, the voltage value VT has dropped to a voltage value V1 and then starts to rise. Since the voltage value VT starts to rise, the control circuit 140 will adjust the clock parameter CP to make the frequency of the output clock signal CLK_O gradually increase to the original operation frequency. In other words, when the voltage variation slope SL changes from less than zero to greater than zero, the control circuit 140 will adjust the clock parameter CP to increase the frequency of the output clock signal CLK_O.

At time point T4, the voltage variation slope SL is greater than zero and the voltage value VT has risen to a second critical voltage value Vth2. At this time, the control circuit 140 adjusts the selection signal SS, so as to control the clock supply circuit 110 to select a second clock signal with a frequency lower than the operation frequency (e.g., the clock signal CLK_B in FIG. 1) among the plurality of clock signals as the supply clock signal CLK_S, and adjusts the clock parameter CP to increase the frequency of the output clock signal CLK_O.

In some embodiments, in addition to being based on whether the voltage value VT reaches the second critical voltage value Vth2 as described above, the control circuit 140 can also determine whether to switch the clock signal selected by the clock supply circuit 110 based on the voltage variation slope SL. For example, in some embodiments, when the voltage variation slope SL is greater than zero and greater than a second critical slope S2, the control circuit 140 will control the clock supply circuit 110 to select a second clock signal having a frequency lower than the operation frequency as the supply clock signal CLK_S, and adjust the clock parameter CP to increase the frequency of the output clock signal CLK_O.

At time point T5, the voltage value VT reaches a stable voltage value Vstb close to the operation voltage value VO. At this time, the control circuit 140 controls the clock supply circuit 110 to select a first clock signal having the same frequency as the operation frequency as the supply clock signal CLK_S, and adjusts the clock parameter CP to make the output clock signal CLK_O gradually approach the original operation frequency.

Finally, at time point T6, the voltage value VT is maintained at a value close to the stable voltage value Vstb, and the voltage variation slope SL has been maintained in a stable slope range (e.g., plus or minus 1%) for a specified time period (e.g., ten cycles of the clock signal). At this time, the control circuit 140 controls the clock supply circuit 110 to keep selecting the first clock signal as the supply clock signal CLK_S, and adjusts the clock parameter CP to not gate the supply clock signal CLK_S, thereby making the output clock signal CLK_O the same as the first clock signal (i.e., original operation frequency).

In some embodiments not shown, the clock supply circuit 110 shown in FIG. 1 may comprise more than two clock sources (e.g., clock sources 111A, 111B and a third clock source). In this case, the clock supply circuit 110 may select one of the three clock signals as the supply clock signal CLK_S based on the clock selection signal SS. In addition, in this case, when the voltage variation slope SL is greater than zero and the voltage value VT of the power supply SP is greater than a third critical voltage value (e.g., a voltage value between the second critical voltage value Vth2 and the stable voltage value Vstb), the control circuit 140 is further configured to control the clock supply circuit 110 to select a third clock signal provided by the third clock source as the supply clock signal CLK_S, and adjust the clock parameter CP to increase the frequency of the output clock signal CLK_O. By setting more clock sources in the clock supply circuit 110, the frequency adjustment device 100 can realize the function of switching between various frequencies.

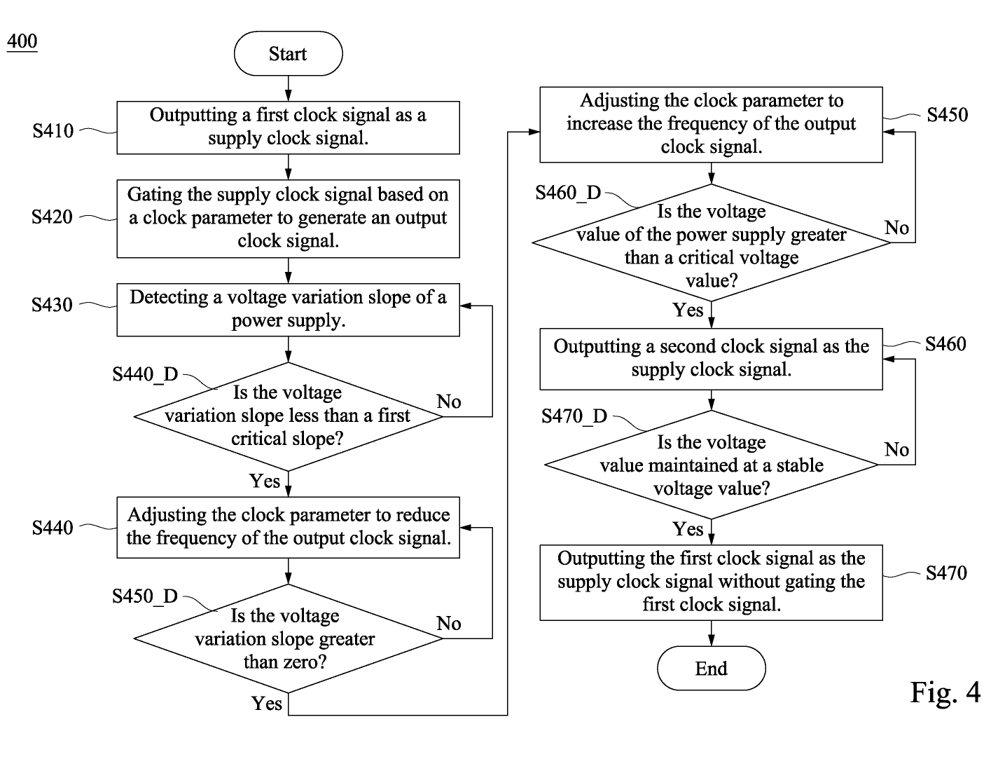

FIG. 4 is a flowchart of a frequency adjustment method 400 in accordance with some embodiments of the present disclosure. The frequency adjustment method 400 is suitable for a frequency adjustment device (e.g., the frequency adjustment device 100 in FIG. 1) operating based on a power supply and an operation frequency. In some embodiments, the frequency adjustment method 400 comprises steps S410, S420, S430, S440, S440_D, S450, S450_D, S460, S460_D, S470 and S470_D.

In step S410, a clock supply circuit (e.g., the clock supply circuit 110 in FIG. 1) outputs a first clock signal as a supply clock signal, wherein the frequency of the first clock signal is equal to the operation frequency of the frequency adjustment device. Next, step S420 will be performed.

In step S420, a clock gating component (e.g., the clock gating component 120 in FIG. 1) gates a supply clock signal based on a clock parameter, so as to generate an output clock signal. Next, step S430 will be performed.

In step S430, a voltage detection circuit (e.g., the voltage detection circuit 130 in FIG. 1) detects a voltage value and a voltage variation slope of a power supply. Next, step S440_D will be performed.

In step S440_D, a control circuit (e.g., the control circuit 140 in FIG. 1) determines whether the voltage variation slope is less than a first critical slope (e.g., the first critical slope S1 in FIG. 3). When the control circuit determines that the voltage variation slope is less than the first critical slope, step S440 will be performed next; when the control circuit determines that the voltage variation slope is not less than (i.e., equal to or greater than) the first critical slope, step S430 will be performed again.

In step S440, the control circuit adjusts the clock parameter transmitted to the clock gating component, so as to reduce the frequency of the output clock signal. Next, step S450_D will be performed.

In step S450_D, the control circuit determines whether the voltage variation slope is greater than zero (i.e., whether the voltage value starts to rise). When the control circuit determines that the voltage variation slope is greater than zero, step S450 will be performed next; when the control circuit determines that the voltage variation slope is not greater than (i.e., equal to or less than) zero, step S440 will be performed again.

In step S450, the control circuit adjusts the clock parameter transmitted to the clock gating component, so as to increase the frequency of the output clock signal. Next, step S460_D will be performed.

In step S460_D, the control circuit determines whether the voltage value of the power supply is greater than a critical voltage value (e.g., the second critical voltage value Vth2 in FIG. 3). When the control circuit determines that the voltage value is greater than the critical voltage value, step S460 will be performed next; when the control circuit determines that the voltage value is not greater than (i.e., equal to or less than) the critical voltage value, step S450 will be performed again.

In step S460, the clock supply circuit selects a second clock signal as the supply clock signal, and the control circuit adjusts the clock parameter to increase the frequency of the output clock signal, wherein the frequency of the second clock signal is lower than the operation frequency of the frequency adjustment device. Next, step S470_D will be performed.

In step S470_D, the control circuit determines whether the voltage value of the power supply is maintained at a stable voltage value (e.g., the stable voltage value Vstb in FIG. 3). When the control circuit determines that the voltage value is maintained at the stable voltage value, step S470 will be performed next; when the control circuit determines that the voltage value is not maintained at the stable voltage value, step S460 will be performed again.

In step S470, the clock supply circuit selects the first clock signal as the supply clock signal again, and the control circuit adjusts the clock parameter to not gate the first clock signal (i.e., the supply clock signal), so that the frequency of the output clock signal is equal to the operation frequency of the frequency adjustment device.

It should be noted that the number and order of steps in the frequency adjustment method 400 of the present disclosure are only examples, and are not intended to limit the present disclosure. Other numbers and orders of steps are within the scope of the present disclosure. In some embodiments, the frequency adjustment method 400 further comprises a step of determining whether the voltage value is less than a first critical voltage value Vth1 as described above. In some embodiments, the frequency adjustment method 400 further comprises a step of determining whether the voltage variation slope is greater than a second critical slope S2.

With the frequency adjustment device 100 and the frequency adjustment method 400 of the present disclosure, the frequency of the selected clock signal can be adjusted in real time when the voltage variation slope of the power supply reaches a specified critical value. In addition to improving the ability to solve the voltage drop problem by performing frequency division in advance, the problem of reduced operating capacity in general frequency adjustment devices due to frequent frequency division when the voltage value of the power supply is close to the critical value can be alleviated.

The above are preferred embodiments of the present disclosure. It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A frequency adjustment device, operating based on a power supply and an operation frequency, and comprising:
a clock supply circuit, configured to output one of a plurality of clock signals as a supply clock signal;
a clock gating component, configured to gate the supply clock signal to generate an output clock signal; and
a control circuit, configured to:
when a voltage variation slope of the power supply is less than a first critical slope, reduce a frequency of the output clock signal, wherein the first critical slope is less than zero;
when the voltage variation slope of the power supply is greater than zero, increase the frequency of the output clock signal; and
when the voltage variation slope is maintained in a stable slope range for a specified time period, control the clock supply circuit to select a first clock signal of the plurality of clock signals as the supply clock signal, and adjust the frequency of the output clock signal to a frequency of the first clock signal, wherein the frequency of the first clock signal is the same as the operation frequency.

2. The frequency adjustment device of claim 1, wherein the control circuit is further configured to:
when a voltage value of the power supply less than a first critical voltage value, control the clock supply circuit to select the first clock signal of the plurality of clock signals as the supply clock signal, and reduce the frequency of the output clock signal.

3. The frequency adjustment device of claim 1, wherein the control circuit is further configured to:
when a voltage value of the power supply rises to greater than a second critical voltage value, control the clock supply circuit to select a second clock signal of the plurality of clock signals as the supply clock signal, and increase the frequency of the output clock signal, wherein a frequency of the second clock signal is lower than the operation frequency.

4. The frequency adjustment device of claim 3, wherein the control circuit is further configured to:
when the voltage value of the power supply is maintained at a stable voltage value for the specified time period, control the clock supply circuit to select the first clock signal as the supply clock signal, and adjust the frequency of the output clock signal to the frequency of the first clock signal.

5. The frequency adjustment device of claim 4, wherein the clock supply circuit comprises:
a first clock source, configured to generate the first clock signal;
a second clock source, configured to generate the second clock signal; and
a clock switching circuit, coupled to the first clock source, the second clock source and the control circuit, and configured to receive a clock selection signal from the control circuit and select one of the first clock signal and the second clock signal as the supply clock signal based on the clock selection signal.

6. The frequency adjustment device of claim 5, wherein the clock supply circuit further comprises:
a third clock source, coupled to the clock switching circuit and configured to generate a third clock signal, wherein a frequency of the third clock signal is higher than the frequency of the second clock signal and lower than the operation frequency,
wherein the clock switching circuit is configured to select one of the first clock signal, the second clock signal and the third clock signal as the supply clock signal based on the clock selection signal, and
wherein the control circuit is further configured to:
when the voltage value of the power supply rises to greater than a third critical voltage value, control the clock supply circuit to select the third clock signal as the supply clock signal, and increase the frequency of the output clock signal, wherein the third critical voltage value is greater than the second critical voltage value and less than the stable voltage value.

7. The frequency adjustment device of claim 1, wherein the control circuit is further configured to:
when the voltage variation slope rises to greater than a second critical slope, control the clock supply circuit to select a second clock signal of the plurality of clock signals as the supply clock signal, wherein a frequency of the second clock signal is lower than the operation frequency.

8. The frequency adjustment device of claim 1, wherein the clock gating component is configured to gate the supply clock signal based on a clock parameter generated by the control circuit,
wherein the clock parameter is a digital signal comprising a plurality of bits, and each of the plurality of bits is in a logic high state or a logic low state, and
the frequency of the output clock signal is positively related to the number of the plurality of bits in the logic high state.

9. A frequency adjustment method, suitable for a frequency adjustment device operating based on a power supply and an operation frequency, and the frequency adjustment method comprises:
outputting, by a clock supply circuit, one of a plurality of clock signals as a supply clock signal;
gating, by a clock gating component, the supply clock signal, so as to generate an output clock signal;
in response to a voltage variation slope of the power supply being less than a first critical slope, reducing, by a control circuit, a frequency of the output clock signal, wherein the first critical slope is less than zero;
in response to the voltage variation slope being greater than zero, increasing, by the control circuit, the frequency of the output clock signal; and
in response to the voltage variation slope being maintained in a stable slope range for a specified time period:
selecting, by the clock supply circuit, a first clock signal of the plurality of clock signals as the supply clock signal; and
adjusting, by the control circuit, the frequency of the output clock signal to a frequency of the first clock signal, wherein the frequency of the first clock signal is the same as the operation frequency.

10. The frequency adjustment method of claim 9, further comprising:
in response to a voltage value of the power supply being less than a first critical voltage value:
selecting, by the clock supply circuit, the first clock signal of the plurality of clock signals as the supply clock signal; and
reducing, by the control circuit, the frequency of the output clock signal.

11. The frequency adjustment method of claim 9, further comprising:
in response to a voltage value of the power supply rising to greater than a second critical voltage value:
selecting, by the clock supply circuit, a second clock signal of the plurality of clock signals as the supply clock signal; and
increasing, by the control circuit, the frequency of the output clock signal, wherein a frequency of the second clock signal is lower than the operation frequency.

12. The frequency adjustment method of claim 11, further comprising:
in response to the voltage value of the power supply being maintained at a stable voltage value for the specified time period:
selecting, by the clock supply circuit, the first clock signal as the supply clock signal; and
adjusting, by the control circuit, the frequency of the output clock signal to the frequency of the first clock signal.

13. The frequency adjustment method of claim 12, wherein outputting, by the clock supply circuit, the one of a plurality of clock signals as the supply clock signal comprises:
generating, by a first clock source, the first clock signal;
generating, by a second clock source, the second clock signal;
receiving, by a clock switching circuit, a clock selection signal from the control circuit; and
selecting, by the clock switching circuit, one of the first clock signal and the second clock signal as the supply clock signal based on the clock selection signal.

14. The frequency adjustment method of claim 13, wherein outputting, by the clock supply circuit, the one of a plurality of clock signals as the supply clock signal further comprises:
generating, by a third clock source, a third clock signal, wherein a frequency of the third clock signal is higher than the frequency of the second clock signal and lower than the operation frequency; and
selecting, by the clock switching circuit, one of the first clock signal, the second clock signal and the third clock signal as the supply clock signal based on the clock selection signal, and
wherein the frequency adjustment method further comprises:
in response to the voltage value of the power supply rising to greater than a third critical voltage value:
selecting, by the clock supply circuit, the third clock signal as the supply clock signal; and
increasing, by the control circuit, the frequency of the output clock signal, wherein the third critical voltage value is greater than the second critical voltage value and less than the stable voltage value.

15. The frequency adjustment method of claim 9, further comprising:
in response to the voltage variation slope rising to greater than a second critical slope, selecting, by the clock supply circuit, a second clock signal of the plurality of clock signals as the supply clock signal, wherein a frequency of the second clock signal is lower than the operation frequency.

16. The frequency adjustment method of claim 9, wherein the clock gating component is configured to gate the supply clock signal based on a clock parameter generated by the control circuit,
wherein the clock parameter is a digital signal comprising a plurality of bits, and each of the plurality of bits is in a logic high state or a logic low state, and
the frequency of the output clock signal is positively related to the number of the plurality of bits in the logic high state.
